(19) United States
(12) Patent Application Publication
(10) Pub. No.: US 2004/0010536 A1
(43) Pub. Date: Jan. 15, 2004

(54) Apparatus for multiplication of data in two's complement and unsigned magnitude formats

(75) Inventors: Jaime H. Moreno, Dobbs Ferry, NY (US); Uzi Shvadron, Mitzpe Aviv (IL); Ayal Zaks, Mitzpe Aviv (IL); Victor V. Zyuban, Yorktown, NY (US)

Correspondence Address: Intellectual Property Law, IBM Corporation, Dept. 39-240, T.J. Watson Research Center, 1101 Kitchawan Road / Route 134, Yorktown Heights, NY, 10598, US

(73) Assignee: International Business Machines Corporation, Armonk, NY

(21) Appl. No.: 10/194,084

(22) Filed: Jul. 11, 2002

(51) Int. Cl. G06F 7/52

(52) U.S. Cl. 708/625

(57) ABSTRACT

A two's complement multiplier is combined with additional circuit elements to provide a multiplier capable of multiplication of two operands represented in any combination of either two's complement (signed) or unsigned magnitude formats, without increasing the size of the multiplier compared a multiplier for both operands represented in the same format; achieving the additional capability by providing independent inversion control to the partial product elements in the left column and the bottom row of the multiplier array, and controlling the generation of the carry-in signal to the carry propagate adder that performs the final addition of the partial products.

### FIELD OF THE INVENTION

The invention relates to circuits for performing signed (two's complement) multiplication, unsigned magnitude multiplication, and the multiplication of two operands of which one is signed (two's complement format) and the other operand is in the unsigned magnitude format.

### BACKGROUND OF THE INVENTION

Many DSP algorithms require an unsigned 32 bit by signed 16 bit multiplication. This operation can be implemented by using a 32-bit multiplier, however, the high power and area cost of 32-bit multiplier does not justify including a 32-bit multiplier on chip. Thus, this operation is typically done on a 16-bit multiplier used for all other 16-bit DSP computations. To perform this operation in addition to the standard 16-bit DSP computations, the 16-bit multiplier must be capable of multiplying numbers in both unsigned magnitude and two's complement formats, as well as multiplying two operands, of which one is in two's complement and the other is in unsigned magnitude formats.

The multiplication of operands in two's complement and unsigned magnitude formats is also required by certain applications such as the processing of video signals, where the luminance component of the video signal is represented in unsigned magnitude format and are multiplied by coefficients that are represented in two's complement format.

The multipliers known in the art are either unsigned multipliers that accept two unsigned operands, or signed multipliers which accept two signed operands. Unsigned operands have values between zero and 2ⁿ−1, where n is the size in bits of the operand. Signed two's complement operands have values between −2ⁿ⁻¹ and 2ⁿ⁻¹−1.

A common approach for building signed multipliers consists of converting an unsigned array multiplier to a two's complement array multiplier using the Baugh-Wooley method The multiplier still accepts two n-bit operands, and some logic is changed and added to the multiplier in order to handle the cases where one or both operands represent negative values. This logic includes complementing the bits of either the input operands or products of the input operands, and extra adders to add constants to the final product.

The original Baugh-Wooley method involves adding three full adders (each receiving three bits and producing a sum bit and a carry bit. The approach is simpler than previously proposed techniques by Pezaris and others that require variants of full-adder cells which receive and produce negatively weighted bits. A modified form of the Baugh-Wooley method can reduce the maximum column height and thus the length of the critical path, and is therefore preferable.

Any unsigned n-bit number can be represented as a signed 2's complement n+1 bit number by adding zero as a most significant bit. Any signed n-bit number can be represented as a signed n+1 bit number by sign-extending it by one bit. A common approach used to multiply mixed operands, where the multiplier is signed and the multiplicand is unsigned or vice versa, is to extend both operands to n+1 bits and use a signed n+1 by n+1 multiplier, as shown in FIG. 1, in which 16-bit operands A and B feed through registers 22 and 23, have their Most Significant Bits (MSBs) specified by units 20 and 21 and are multiplied in 17×17 bit multiplier 10, producing a 34 bit product. The product is then shortened to 2n (32) bits. Thus a 17-by-17 bit signed multiplier is used to multiply two 16-bit numbers, one being signed and the other unsigned, and the product is shortened to 32 bits.

However, the use of a larger (n+1)-bit multiplier increases the power dissipation of the multiplier. Also, it leads to an increase in the critical path through the multiplier, which may affect the operating frequency of the chip. The area of an array multiplier is proportional to the square of the multiplier width. The worst case power is also proportional to the square of the multiplier width, and the delay through the array multiplier is linearly proportional to the width. Therefore, using an (n+1)-bit multiplier instead of an n-bit multiplier results in approximately 2/n (((n+1)²−n²)/n²=2/n+1/n²) relative increase in power and 1/n(((n+1)−n)/n=1/n) relative increase in delay. Detailed simulations can show that using a 17-bit multiplier instead of a 16-bit multiplier can result in up to 12% increase in power dissipation and up to 8% increase in the critical path delay.

Accordingly, there is a need for a multiplier which can multiply numbers in two's complement and unsigned magnitude formats, including any combination of the two formats, with little overhead in power and little increase in size when compared to a multiplier for signed or unsigned operands.

### SUMMARY OF THE INVENTION

The invention relates to circuits for performing signed (two's complement) multiplication, unsigned magnitude multiplication, and the multiplication of two operands of which one is in two's complement format and the other operand is in the unsigned magnitude format.

A feature of the invention is the provision of partial product elements that controllably invert the sign of their partial product.

Another feature of the invention is the generation of bits to be added in the nth, (n+1)th and 2nth positions of the product in response to the formats of the operands.

### BRIEF DESCRIPTION OF THE DRAWINGS

FIG. 1 shows an overall view of a prior art multiplier.

FIG. 2 shows, in partially pictorial, partially schematic fashion, a multiplier according to the invention.

FIG. 3 shows, in partially pictorial, partially schematic fashion, a first embodiment of the invention.

FIG. 4 shows representations and truth tables of elements of the embodiment of FIG. 3.

FIG. 5 shows, in partially pictorial, partially schematic fashion, a second embodiment of the invention.

FIG. 6 shows representations and truth tables of elements of the embodiment of FIG. 5.

FIG. 7 shows representations and truth tables of additional elements of the embodiment of FIG. 5.

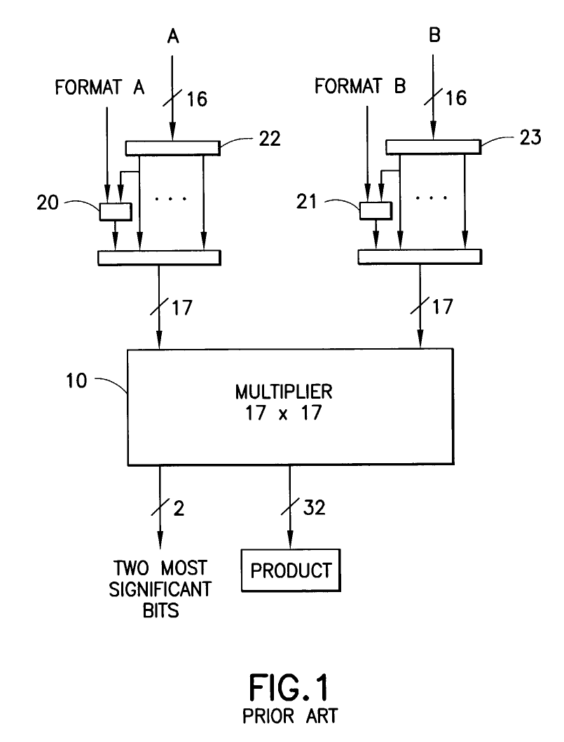

### DETAILED DESCRIPTION OF THE INVENTION

The principle of operation of a unit capable of multiplying operands in two's complement and unsigned magnitude representations is based on the following mathematical foundation.

In what follows, the term “a signed operand” will be used to refer to an operand that is given in two's complement format, and the term “an unsigned operand” will be used to refer to an operand that is given in unsigned magnitude format. Let p(x) denote 2 to the power of x, for x greater than or equal to 0 (e.g., p(0)=1, p(1)=2, p(2)=4, and so on). Let a[n], . . . , a[1] be n bits that represent an unsigned number A in the unsigned magnitude form using the standard binary representation, wherein a[n] is the most significant bit.

The numerical value of A is equal to:

$$\begin{matrix}A = a [ 1 ] p ( 0 ) + a [ 2 ] p ( 1 ) + … + a [ n ] p ( n - 1 ) \\ = {\sum }_{i = 1 , … , n} ( a [ i ] p ( i - 1 ) ) .\end{matrix}$$

Let b[n], . . . ,b[1] be n bits that represent a signed number B (represented in the two's complement form) using the standard two's complement binary representation, where b[n] is the most significant bit. The numerical value of B is equal to:

$$\begin{matrix}B = b [ 1 ] p ( 0 ) + b [ 2 ] p ( 1 ) + … + b [ n - 1 ] p ( n - 2 ) - b [ n ] p ( n - 1 ) \\ = - b [ n ] p ( n - 1 ) + {\sum }_{i = 1 , … , n - 1} ( b [ i ] p ( i - 1 ) )\end{matrix}$$

The product A times B is equal to:

$$\begin{matrix}AB = - b [ n ] p ( n - 1 ) ( {\sum }_{i = 1 , … , n} ( a [ i ] p ( i - 1 ) ) ) + \\ ( {\sum }_{i = 1 , … , n - 1} ( b [ i ] p ( i - 1 ) ) ) ( {\sum }_{i = 1 , … , n} ( a [ i ] p ( i - 1 ) ) ) \\ = {\sum }_{i = 1 , … , n} ( - b [ n ] a [ i ] p ( n - 2 + i ) ) + \\ {\sum }_{j = 1 , … , n - 1} ( {\sum }_{i = 1 , … , n} ( a [ i ] b [ j ] p ( i + j - 2 ) ) ) .\end{matrix}$$

In order to efficiently implement the multiplication algorithm using simple adder cells, there must be no subtractions in the expression above. In order to have only additions and no subtractions, we use the two's complement of b[n]a[i] which is equal to (1−b[n]a[i]), and write the product AB in the following form:

$$\begin{matrix}AB = {\sum }_{i = 1 , … , n} ( ( 1 - b [ n ] a [ i ] ) p ( n - 2 + i ) - {\sum }_{i = 1 , … , n} ( p ( n - 2 + i ) + \\ {\sum }_{i = 1 , … , n} ( {\sum }_{j = 1 , … , n - 1} ( a [ i ] b [ j ] p ( i + j - 2 ) ) \\ The middle term , {\sum }_{i = 1 , … , n} p ( n - 2 + i ) ) , \\ is equal to : p ( n - 1 ) + p ( n ) + … + p ( 2 n - 2 ) \\ = p ( 2 n - 1 ) - 1 - ( p ( n - 1 ) - 1 ) \\ = p ( 2 n - 1 ) - p ( n - 1 )\end{matrix}$$

The final formula, for the case when A is unsigned and B is signed, is:

$$\begin{matrix}( 1 ) AB = {\sum }_{i = 1 , … , n - 1} ( {\sum }_{j = 1 , … , n - 1} ( a [ i ] b [ j ] p ( i + j - 2 + & ( 1 a ) \\ {\sum }_{j = 1 , … , n - 1} ( a [ n ] b [ j ] p ( n - 2 + j ) ) + & ( 1 b ) \\ {\sum }_{i = 1 , … , n - 1} ( 1 - a [ i ] b [ n ] ) p ( n - 2 + i ) ) + & ( 1 c ) \\ ( 1 - a [ n ] b [ n ] ) p ( 2 n - 2 ) + & ( 1 d ) \\ p ( n - 1 ) - & ( 1 e ) \\ p ( 2 n - 1 ) & ( 1 f )\end{matrix}$$

Similar analysis shows that if A is signed and B is unsigned, then:

$$\begin{matrix}( 2 ) AB = {\sum }_{i = 1 , … , n - 1} ( {\sum }_{j = 1 , … , n - 1} ( a [ i ] b [ j ] p ( i + j - 2 ) ) ) + & ( 2 a ) \\ {\sum }_{j = 1 , … , n - 1} ( 1 - a [ n ] b [ j ] p ( n - 2 + j ) ) + & ( 2 b ) \\ {\sum }_{i = 1 , … , n - 1} ( a [ i ] b [ n ] ) p ( n - 2 + i ) ) + & ( 2 c ) \\ ( 1 - a [ n ] b [ n ] ) p ( 2 n - 2 ) + & ( 2 d ) \\ p ( n - 1 ) - & ( 2 e ) \\ p ( 2 n - 1 ) & ( 2 f )\end{matrix}$$

When operands A and B are both signed, we have:

$$\begin{matrix}( 3 ) AB = {\sum }_{i = 1 , … , n - 1} ( {\sum }_{j = 1 , … , n - 1} ( a [ i ] b [ j ] p ( i + j - 2 ) ) ) + & ( 3 a ) \\ {\sum }_{j = 1 , … , n - 1} ( 1 - a [ n ] b [ j ] p ( n - 2 + j ) ) + & ( 3 b ) \\ {\sum }_{i = 1 , … , n - 1} ( 1 - a [ i ] b [ n ] ) p ( n - 2 + i ) ) + & ( 3 c ) \\ ( a [ n ] b [ n ] ) p ( 2 n - 2 ) + & ( 3 d ) \\ p ( n ) - & ( 3 e ) \\ p ( 2 n - 1 ) & ( 3 f )\end{matrix}$$

And finally when operands A and B are both unsigned, we have:

$$\begin{matrix}( 4 ) AB = {\sum }_{i = 1 , … , n} ( {\sum }_{j = 1 , … , n} ( a [ i ] b [ j ] p ( i + j - 2 ) ) ) + & \\ = {\sum }_{i = 1 , … , n - 1} ( {\sum }_{j = 1 , … , n - 1} ( a [ i ] b [ j ] p ( i + j - 2 ) ) ) + & ( 4 a ) \\ {\sum }_{j = 1 , … , n - 1} ( a [ n ] b [ j ] ) p ( n - 2 + j ) ) + & ( 4 b ) \\ {\sum }_{i = 1 , … , n - 1} ( a [ i ] b [ n ] ) p ( n - 2 + i ) ) + & ( 4 c ) \\ a [ n ] b [ n ] p ( 2 n - 2 ) & ( 4 d )\end{matrix}$$

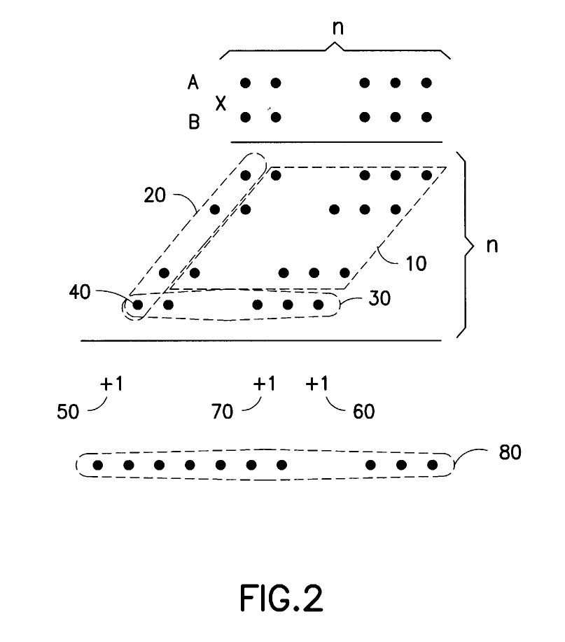

Now referring to FIG. 2, which depicts the array of single-bit partial products resulting from the bit-by-bit multiplication of the two operands. Two operands A and B are shown schematically at the top of the Figure, where for the purpose of this Figure operands A and B can each be either signed or unsigned. An array of partial products comprises main array 10 and three special arrays −20, 30 and 40.

Array 20, referred to as the first MSB array, contains the partial products of the first bit in A with the bits (except for the MSB) in B, i.e. A[n]B[j] where index [n] designates the most significant bit of an operand, and j is an index in the range from 1 to n−1. Array 30, referred to as the second MSB array, contains the corresponding partial products of the first bit in B with the bits (except for the MSB) in A, i.e. B[n]A[j] where index [n] designates the most significant bit of an operand, and j is an index in the range from 1 to n−1. Array 40, referred to as the third MSB array, contains the product of the two MSBs, i.e. A[n]B[n]. At the bottom, the total product is shown as array 80. Just above array 80, bits 50, 60 and 70 are added as described below to handle signed operands.

The first term (1a) in equation (1) above corresponds to the addition of all the partial products in block 10 excluding arrays 20, 30 and 40, i.e. all partial products leaving out those that correspond to the multiplication of the most-significant bit of operand A with the bits of operand B (arrays 20 and 40), and those that correspond to the multiplication of the most significant bit of operand B with the bits of operand A (arrays 30 and 40). Note that this first term (1a) remains exactly the same if instead of having A unsigned and B signed, we were to deal with A signed and B unsigned (2a), both A and B signed (3a) or both A and B unsigned (4a). This term of the expression is identical to a similar expression present in standard multipliers (wherein both operands are represented either in two's complement format or both represented in unsigned magnitude format). This term 1a can be implemented using any conventional structure as those used in prior art multipliers. The third term (1c) in equation (1) above corresponds to the addition of the inverted partial products that correspond to the multiplication of the most-significant bit of operand B with the bits of operand A (array 30), assuming that operand A is unsigned and operand B is signed. If operand A is signed and operand B is unsigned, then the corresponding second term (2b) in (2) would correspond to the multiplication of the most significant bit of operand A with the bits of operand B. These terms (1c and 2b) are similar to an expression presented in the standard two's complement Baugh-Wooley multipliers.

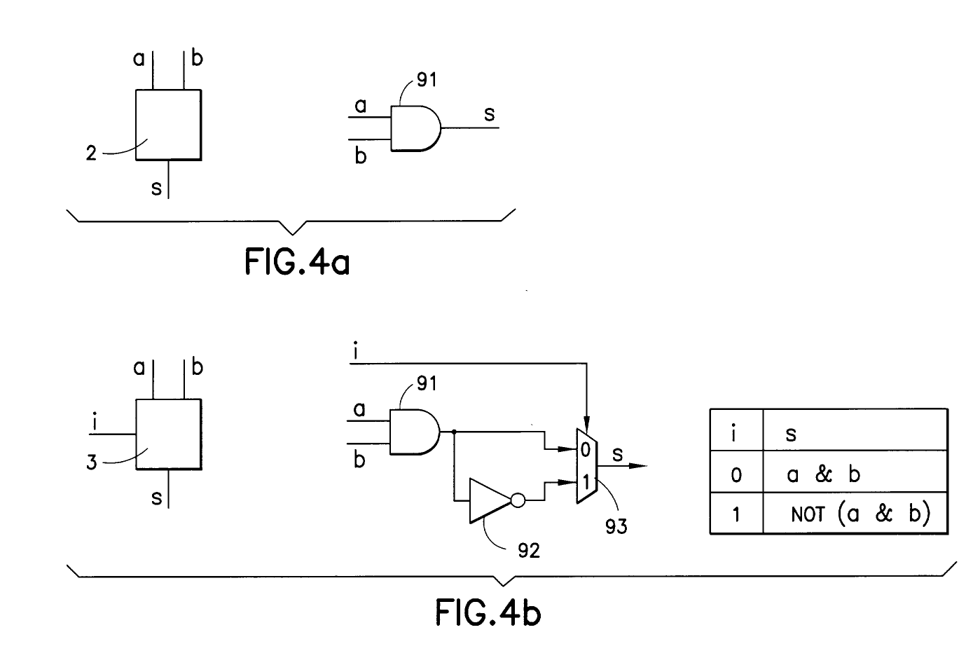

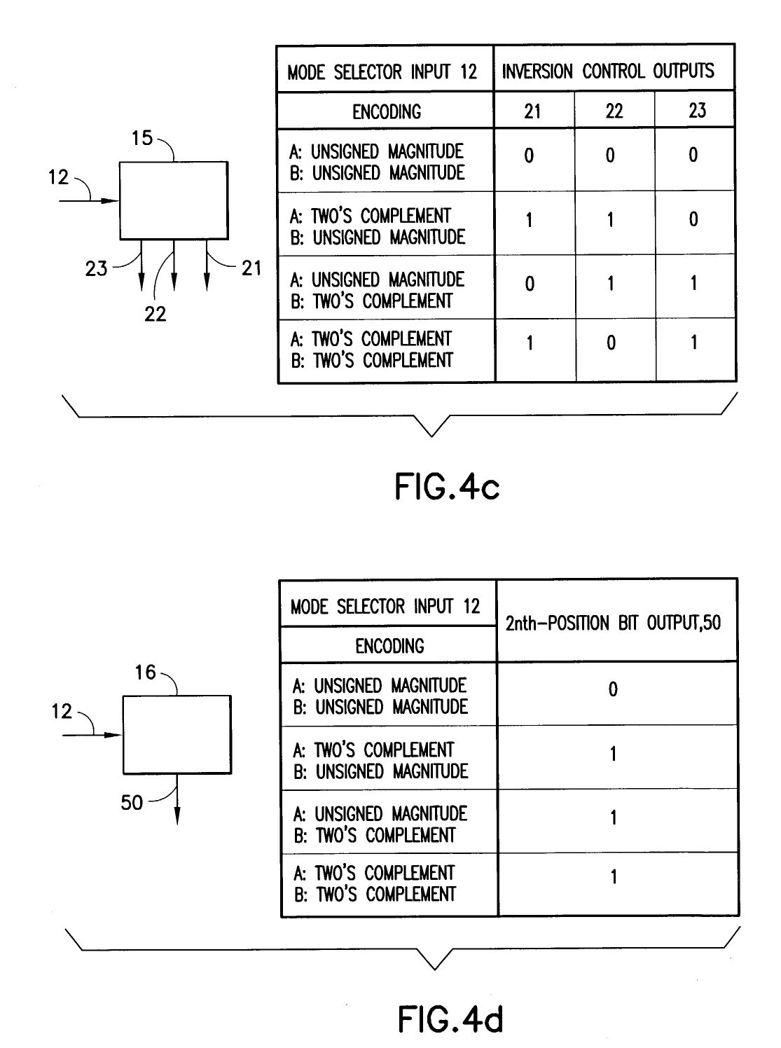

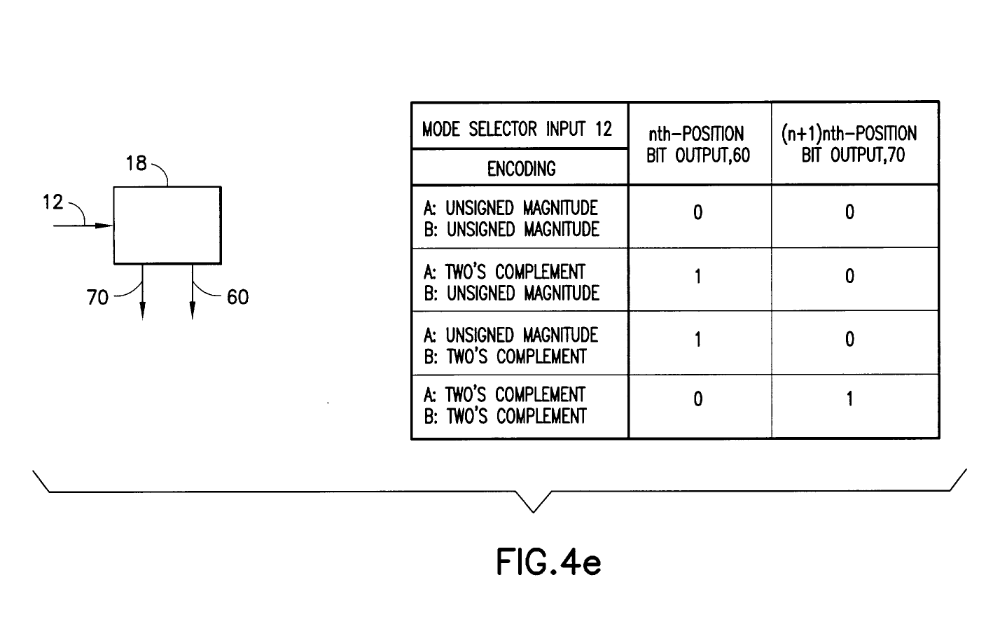

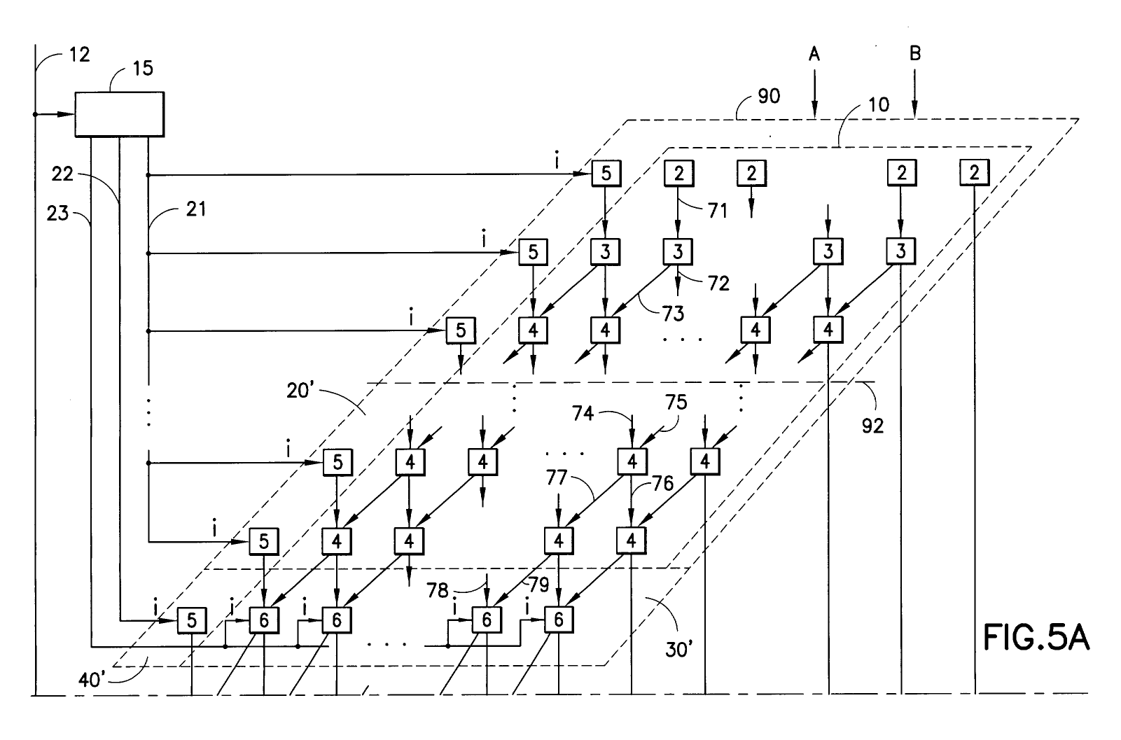

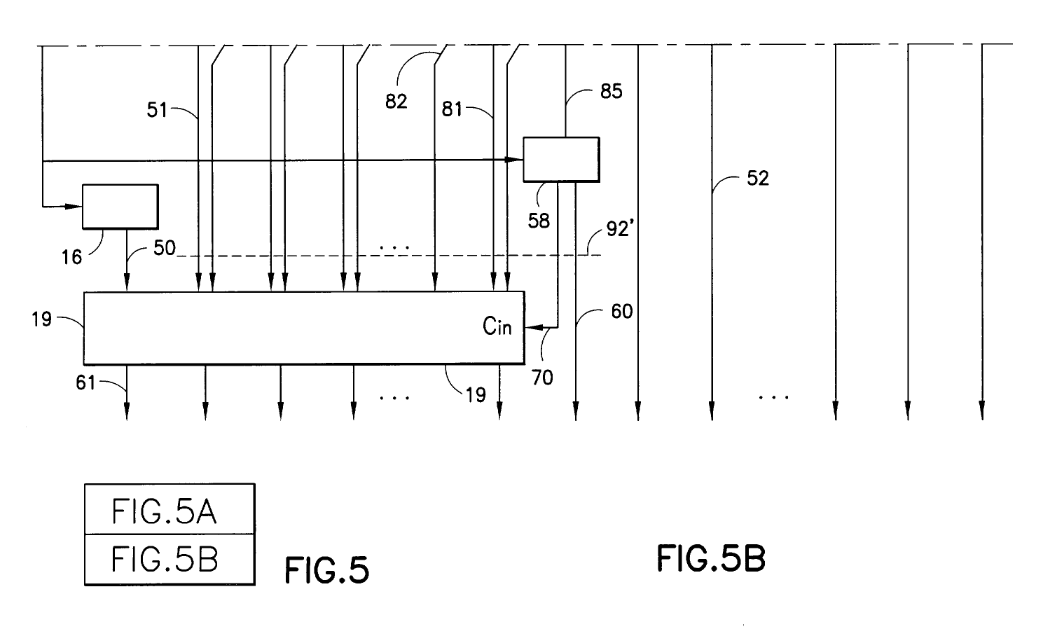

One major difference is that, in the algorithm disclosed in this invention, one of the two sets of partial products 20 and 30 has to be inverted when one of the operands is signed while the other operand is unsigned. To perform multiplications on operands which are both signed, both partial products 20 and 30 are to be inverted (3b, 3c), whereas partial product 40 (which corresponds to the multiplication of the most significant bit of A with the most significant bit of B) is not to be inverted (3d). Finally, to perform multiplications on operands which are both unsigned, none of the partial products is to be inverted. Looking ahead, the truth tables in FIGS. 4C and 5A specify which partial products are to be inverted. The described result is implemented according to the present invention by equipping the partial product generators for elements 20, 30 and 40 with means for independently controllable inversion, and providing logic for generating three independent inversion control signals (based on the multiplier control inputs indicating the required multiplication type): one for the partial products 20, one for the partial products 30, and one for element 40.

The term (1e) (p(n−1)) in equation (1) above corresponds to adding ‘1’ to the final product in the n-th position from the right (60). This is different from the two's complement Baugh-Wooley multiplier which requires adding a ‘1’ to the final product in the (n+1)-th position from the right (70) instead (that is, adding p(n) instead of p(n−1)).

Multiplications on operands that are both in two's complement format still require adding ‘1’ to the final product in the (n+1)-th position from the right (70).

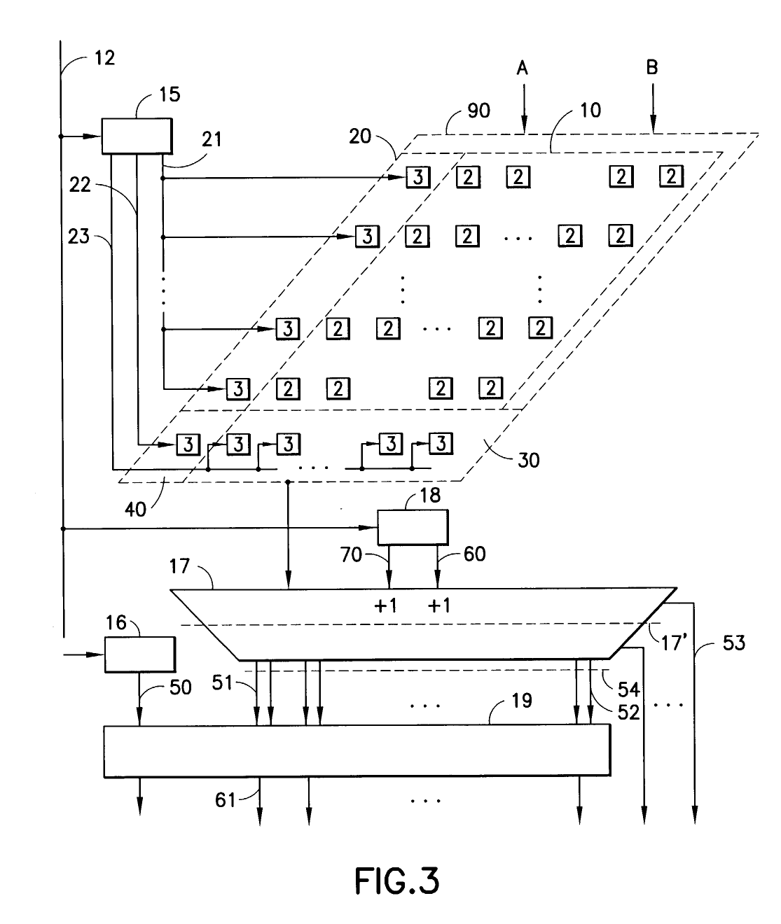

Finally, to perform multiplications on operands which are both in the unsigned magnitude format, no extra ‘1’ needs to be added in either the n-th or the (n+1)-th position of the product. This result is achieved according to the present invention by providing means that controllably generate bits (referred to as bit-generation means 18 in FIG. 3) in the n-th and (n+1)-th positions to be added (by bit-addition means that may be positioned as is convenient) to the final product, depending on the multiplier control inputs that indicate the required multiplication type.

The term (1f) (−p(2n−1)) in equation (1) above corresponds to subtracting p(2n−1). It is identical to a similar term in the two's complement Baugh-Wooley multipliers. The subtraction of this term is equivalent to adding a ‘1’ to the final product in the most significant position of the 2n-bit result (50), which is interpreted as a signed two's complement number with a negative weight. The addition of this ‘1’ needs to be disabled when the multiplier operates on operands that are both in the unsigned magnitude format, and only then. This result is achieved by bit-addition means that controllably add a ‘1’ in the most significant position of the 2n-bit result (50), depending on the multiplier

FIG. 3 shows a preferred implementation as an integrated circuit of the invented method for multiplying numbers in two's complement and unsigned magnitude formats using the same hardware.

The multiplier hardware, according to the first preferred embodiment of the current invention, consists of a partial product generator array 90 containing first, second and third MSB arrays 20, 30 and 40, respectively, a partial product reduction network 17, a final result adder 19, inversion control block 15, 2nth-position (signed) bit generator 16, and (n+1)-nth-position bit generator (mixed format bit generator) 18. The multiplier has two n-bit primary inputs for the input operands A and B, a 2n-bit primary output for the result of the multiplication (61), and a control input 12 that encodes the format of the input operands A and B. Control input 12 encodes up to four types of multiplication instructions: 1) treat both operands A and B as numbers represented in the unsigned magnitude format; 2) treat operand A as a number represented in the two's complement format and treat operand B as a number represented in the unsigned magnitude format; 3) treat operand B as a number represented in the two's complement format and treat operand A as a number represented in the unsigned magnitude format; and 4) treat both operands A and B as numbers represented in the two's complement format. Any encoding of this information can be used for the control input 12. Some of the four combinations can be omitted at the system designer's discretion.

The partial product generator array 90 generates n\hat{ }2 (n-square) partial products of the form Ai*Bj for i and j ranging from 1 to n. Each partial product is generated by a partial product generator cell 2 or 3.

All partial product generator cells except for those in the left column (left column is the column that generates partial products of the form A[n]*B[j], where A[n] is the most significant bit of operand A and j is an index in the range from 1 to n—denoted as arrays 20 and 40 in FIG. 2) and those on the last row (last row is the row that generates partial products of the form A[j]*B[n], where B[n] is the most significant bit of operand B and j is an index in the range from 1 to n—denoted as arrays 30 and 40 in FIG. 2) are implemented using AND gates as shown in FIG. 4a. These partial product generator cells are designated as ‘2’ in FIG. 3, and are grouped in subarray 10 in FIG. 3.

=

Conventionally, multipliers are laid out as indicated in partially pictorial, partially schematic fashion in FIG. 2. Those skilled in the art are aware that the order of multiplication can be interchanged and that an array layout is preferred but not absolutely required. Accordingly, in the claims the term “left column” will mean those partial products that correspond to the multiplication of the most-significant bit of operand A with the bits of operand B (groups 20 and 40 in FIG. 2), and the term “last row” will mean those partial products that correspond to the multiplication of the most significant bit of operand B with the bits of operand A (groups 30 and 40 in FIG. 2). Also, the terms “first MSB array” means array 20 in FIG. 2, “second MSB array” means array 30 in FIG. 2 and “third MSB array” means array 40 in FIG. 2; (and corresponding groups or arrays in other embodiments).

The partial product generator cells excepted in the preceding paragraph (those in the left column and the last row of the array) are designated as 3 in FIG. 3. Their implementation is shown in FIG. 4b. The partial product generator cell 3 has two operand inputs a and b and an inversion control input i. The inversion control inputs of these cells are connected to the inversion control block 15 in FIG. 3. The table in FIG. 4b shows the truth table of the partial product generator 3, and the gate-level diagram shows a suggested gate-level implementation. Any other gate or transistor implementation that complies with the truth table can be used as well.

FIG. 4c shows the truth table and a schematic representation of the inversion control block 15. Its inputs are connected to the control input 12 of the multiplier, and its outputs are connected to the inputs i of the partial product generator cells 3 in the left column and the last row of the array in FIG. 3. Output 21 is connected to the partial product generator cells on the left column, except for partial product generator cell 40. Output 22 is connected to the partial product generator cell 40 in the lower left corner of the partial product generator array 90. Output 23 is connected to the partial product generator cells on the last row 30, except for the partial product generator cell 40. The truth table in FIG. 4c shows the implementation of the inversion control block 15. The gate specific implementation of the inversion control block depends on the encoding of the control input 12. Any combination of gates, readily implemented by those skilled in the art, that implements the truth table in FIG. 4c can be used. Those skilled in the art will readily be able to modify the inversion control block 15 and partial product generator cells with inversion control 3 in the case when an inverted version of the inversion control signals 21, 22 or 23 (all or any of them) is used.

FIG. 4d shows the truth table and a schematic representation of the 2nth-position bit generator 16. Its input is connected to the control input 12 of the multiplier, and its output 50 is connected to the input of the adder 19, at the most significant bit position. The truth table in FIG. 4d shows the implementation of the 2nth-position bit generator 16. The gate specific implementation of the circuit depends on the encoding of the control input 12. Any combination of gates that implements the truth table in FIG. 4d can be used.

FIG. 4e shows the truth table and a schematic representation of the (n+1)-nth-position bit generator 18. Its input is connected to the control input 12 of the multiplier, and its outputs 60 and 70 are connected to the inputs of the reduction network 15. The output 70 is connected to the input of the reduction network 17, at the position of the (n+1)th bit from the right (counting from the least significant bit position). The output 60 is connected to the input of the reduction network 17, at the position of the nth bit from the right (counting from the least significant bit position). The truth table in FIG. 4e shows the implementation of the (n+1)-nth-position bit generator 18. The gate specific implementation of the circuit depends on the encoding of the control input 12 in FIG. 2. Any combination of gates that implements the truth table in FIG. 4e can be used.

The partial product reduction network 17 in FIG. 3 can be implemented as any conventional prior art reduction tree, known to those skilled in multipliers. Depending on the implementation, it may have a number of outputs at the least significant positions that do not need to go to the final adder (shown as lines 53 in FIG. 3), and a number of outputs (denoted by numerals 51-52) at the most significant position of the final product that are connected to the inputs of the final adder.

The adder 19 in FIG. 3 can be implemented as any conventional carry-propagate adder, known to those skilled in computer arithmetic. Examples of possible implementation include carry look-ahead adder, carry select adder, Kogge adder, carry ripple adder, etc. The outputs 61 of the adder 19 are connected to the appropriate outputs (80 in FIG. 2) of the multiplier, according to the conventional scheme known to those skilled in multipliers.

If required by cycle time considerations, the multiplier in FIG. 3 may be pipelined into two or more stages. In the pipelined implementation of the multiplier, latches are inserted inside the reduction network 17, and at the outputs of the reduction network 51-52. These latches are shown schematically in FIG. 3 as dotted lines 17′ and 54. The 2nth and (n+1)-nth-position bit generators 16 and 18 are pipelined accordingly, so that the outputs of these blocks are delayed by the appropriate number of cycles. With two sets of latches, the multiplier is divided into three stages, so that three sets of operands may be processed simultaneously. Any pipelining mechanism known to those skilled in the art can be used. For the purposes of the claims, latches, delay circuits and control circuits will be collectively referred to as pipeline means.

Depending on the required functionality, the multiplier in FIG. 3 may have a number of additional control inputs that control additional functionality of the multiplier know to those skilled in DSP arithmetic, such as multiplication with saturation, multiplication with a shift and so on. These features are independent of the method disclosed in this invention. Those skilled in the art will readily be able to combine the additional functionality with the method disclosed in this patent.

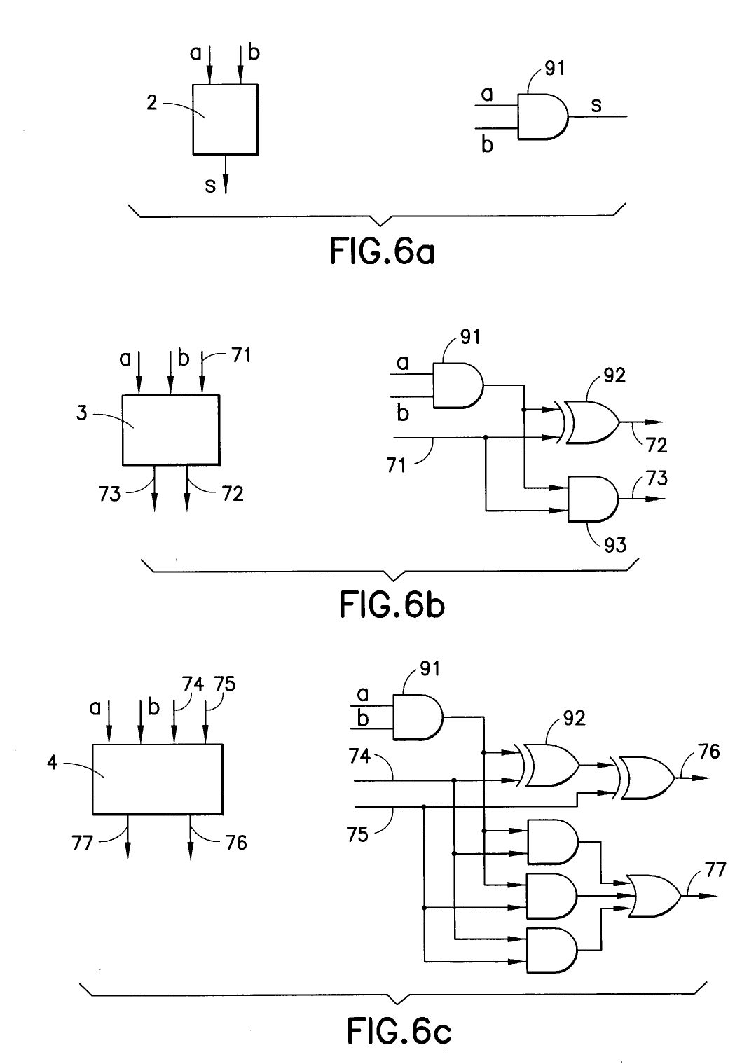

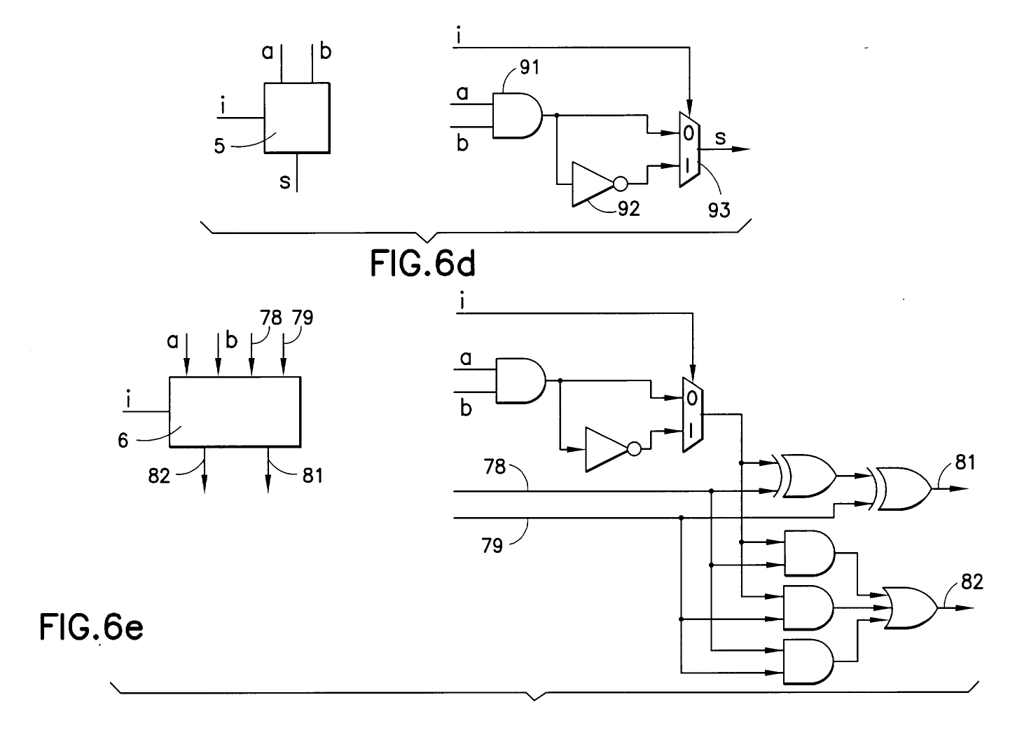

FIG. 5 shows an alternative implementation as an integrated circuit of the inventive multiplier. Elements that are unchanged from the embodiment of FIG. 3 will be specified. Otherwise, reference numerals in FIG. 5 denote elements as specified in FIG. 6 or in the text. The multiplier hardware, according to this embodiment of the current invention, consists of a partial product generator array 90 organized into an array multiplier, a final result adder 19, inversion control block 15, 2nth-position bit generator 16, and carry-in generator 18. The multiplier has two n-bit inputs for the input operands A and B, a 2n-bit output for the result of the multiplication (61 in FIG. 3), and a control input 12 that encodes the format of the input operands A and B. Control input 12 encodes up to four types of multiplication instructions as in FIG. 3.

The partial product generator array 90 generates n² (n-square) partial products of the form Ai*Bj for i and j ranging from 1 to n. Each partial product is generated by one of partial product generator cells 2, 3, 4, 5 or 6. The inputs and outputs of partial product generators are connected according to the conventional scheme of the array multiplier known to those skilled in the art. On the top row, the outputs of the cell generators pass on lines 71 to the next row. On the second row, the output of cell generators 3 passes on lines 72 and the carry bits pass on lines 73. Similarly for the third and subsequent rows, the output of cell generators 4 passes on lines 74, 76, 78, etc. and the carry bits pass on lines 74, 77, 79, etc. The use of different generators 2, 3 and 4 is not required, but saves space.

All partial product generator cells except for those in the left column and those on the last row (i.e. cells 2, 3 and 4 in FIG. 5) are implemented according to the multiplier cells of a conventional array multiplier, known to those skilled in the art an example of which is shown in FIGS. 6a, 6b and 6c. These cells are grouped in subarray (main array of partial product generators) 10 in FIG. 5. The cells on the first row are implemented as AND gates 91 as shown in FIG. 6a. These partial product generator cells are designated as 2 in FIG. 5. The cells 3 on the second row are implemented as half adders with an AND gate 91 at one of the inputs, as shown in FIG. 6b. The cells 4 on the remaining rows of subarray 10 in FIG. 5 are implemented as full adders with an AND gate 91 at one of the inputs, as shown in FIG. 6c. The circuits in FIGS. 6a, 6b and 6c are conventional and are known to those skilled in the art.

The partial product generator cells in the left column of array 90 (first MSB array 20′) are designated with numeral 5 in FIG. 5. Their implementation is shown in FIG. 6d. The partial product generator cell 5 has two operand inputs a and b and an inversion control input i. The inversion control inputs of these cells are connected to output 21 of the inversion control block 15 in FIG. 5. The diagram in FIG. 6d shows a gate-level implementation. Any other gate or transistor implementation that complies with the truth table in FIG. 4b can be used as well.

The partial product generator cells in the last row of array 90 (second MSB array 30′) except for the partial product generator cell (in the lower left corner of array 90) that is also on the left column are designated with numeral 6 in FIG. 5 (third MSB array 40′). Their implementation is shown in FIG. 6e. The partial product generator cell 6 is similar to a full adder with an AND gate at one of the outputs shown in FIG. 6c. In addition to that, the partial product generator 6 has an inversion control input i that controls the inversion of the partial product, as shown in FIG. 6c. The inversion control inputs of cells 6 are connected to output 23 of the inversion control block 15 in FIG. 5. Any other gate or transistor implementation that implements the same logic function can be used in place of the circuit in FIG. 6e.

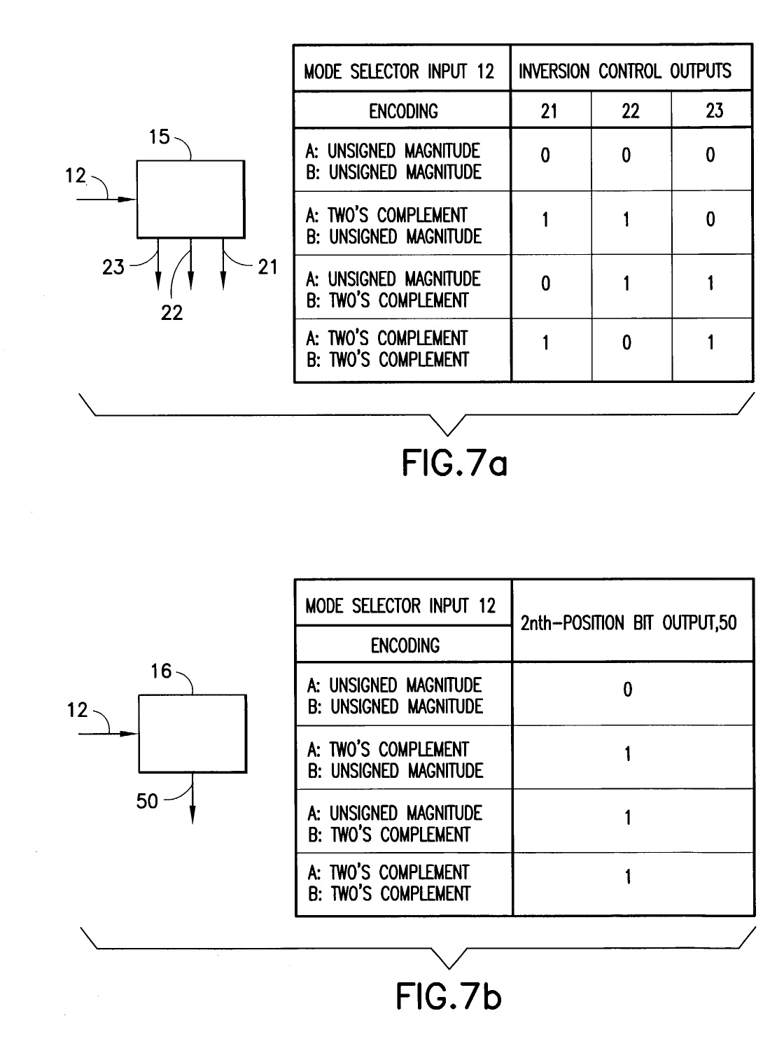

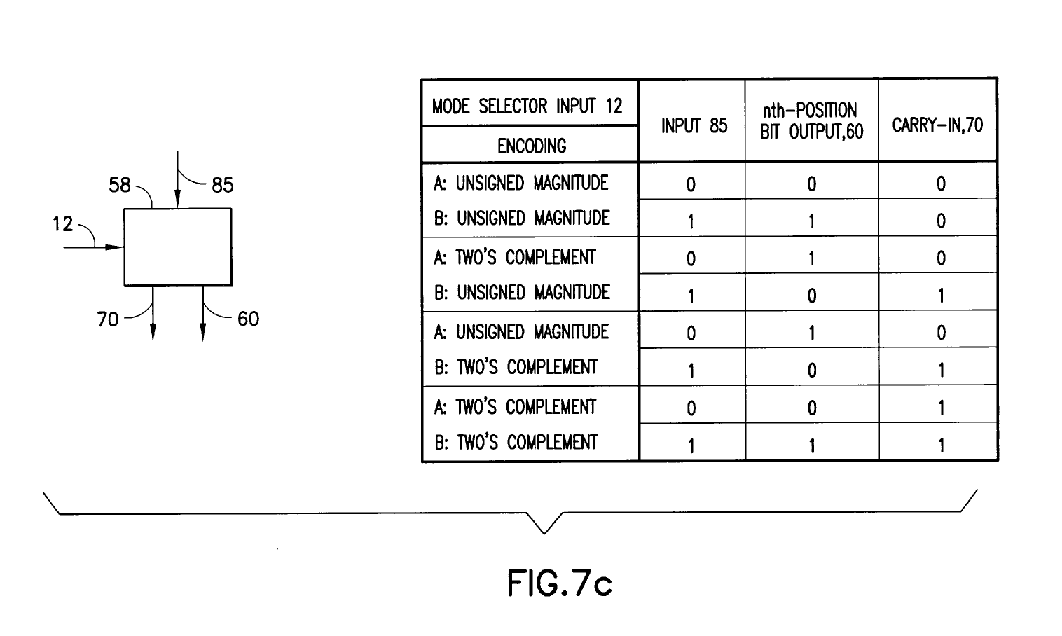

FIG. 7a shows the truth table and implementation of the inversion control block 15, which is the same as that in FIG. 3. Its inputs are connected to the control input 12 of the multiplier, and its outputs are connected to the inputs i of the partial product generator cells in the left column and the last row of the array in FIG. 5. Output 21 is connected to the partial product generator cells on the left column, except for the partial product generator cell 40′ on the left column and the last row (the cell that generates partial product A[n]*B[n], where A[n] is the most significant bit of operand A and B[n] is the most significant bit of operand B). Output 22 is connected to the partial product generator cell 40′ in the lower left corner of array 90. Output 23 is connected to the partial product generator cells on the last row, except for the partial product generator cell 40′. The truth table in FIG. 7a shows the implementation of the inversion control block 15. The gate specific implementation of the inversion control block depends on the encoding of the control input 12. Any combination of gates that implements the truth table in FIG. 7a can be used. It should be obvious to those skilled in the art how to modify the inversion control block 15 and partial product generator cells with inversion control 3 in case when an inverted version of the inversion control signals 21, 22 or 23 (all or any of them) is used.

FIG. 7b shows the truth table and implementation of the 2nth-position bit generator 16. Its inputs are connected to the control input 12 of the multiplier, and its output 50 is connected to the input of the adder 19, at the most significant bit position. The truth table in FIG. 7b shows the implementation of the 2nth-position bit generator 16. The gate specific implementation of the circuit depends on the encoding of the control input 12. Any combination of gates that implements the truth table in FIG. 7b can be used.

FIG. 7c shows the truth table and implementation of the carry-in generator 58. Its input 85 is connected to the sum output of the partial product generator cell in the lower right corner in FIG. 5. This is the cell that generates the partial product A[n]*B[n], where A[n] is the least significant bit of operand A, and B[n] is the most significant bit of operand B. The rest of the inputs of block 58 are connected to the control input 12 of the multiplier.

Output 60 of block 58 is connected to the output of the multiplier, position n, counting from the least significant bit. Output 70 is connected to the carry-in input of the adder 19. The truth table in FIG. 7c shows the implementation of the carry-in generator 58. The gate specific implementation of the circuit depends on the encoding of the control input 12. Any combination of gates that implements the truth table in FIG. 7c can be used.

The adder 19 in FIG. 5 can be implemented as any conventional carry-propagate adder, known to those skilled in computer arithmetic. Examples of possible implementations include carry look-ahead adder, carry select adder, Kogge adder, carry ripple adder, etc. The best performance is achieved using an adder that does not have the carry-in signal on the critical path, such as carry look-ahead adder. The outputs of the adder 19 are connected to the appropriate outputs 61 of the multiplier, according to the conventional scheme known to those skilled in multipliers.

Depending on cycle time requirements, the multiplier in FIG. 5 may be pipelined into two or more stages. In the pipelined implementation of the multiplier, latches are inserted at the inputs of the adder 19, and/or inside the array 90. These latches are shown schematically in FIG. 5 as dotted lines 92 and 92′. The 2nth and carry-in generators 16 and 58 are pipelined accordingly, so that the outputs of these blocks are delayed by the appropriate number of cycles. Any pipelining mechanism known to those skilled in the art can be used.

Depending on the required functionality, the multiplier in FIG. 5 may have a number of additional control inputs that control additional functionality of the multiplier known to those skilled in DSP arithmetic, such as multiplication with saturation, multiplication with a shift and so on. These features are independent of the method disclosed in this invention.

Those skilled in the art will readily be able to combine the additional functionality with the method disclosed in this patent.

Those skilled in the art will be aware that the embodiment illustrated in FIG. 3 includes a compressor tree and is therefore faster for high width multiplication than the embodiment of FIG. 5. On the other hand, an array multiplier, such as the FIG. 5 embodiment is more regular, has shorter wires in the layout and has lower power dissipation than the embodiment of FIG. 5 The embodiment of FIG. 3 is preferred for high-width multiplication and the embodiment of FIG. 5 is preferred for low width multiplication.

While the invention has been described in terms of a pair of preferred embodiments, those skilled in the art will recognize that the invention can be practiced in various versions within the spirit and scope of the following claims.

We claim:

1. A multiplier adapted for operating on operands represented in any combination of two's complement and unsigned magnitude formats, comprising:
a set of partial product generators, comprising a main array of partial product generating units a first MSB array, a second MSB array and a third MSB array, in which units in said first second and third MSB arrays include controllable means for inverting the partial product generated therein in response to a signal from an inversion control unit;
a signed bit generation circuit connected to said inversion control unit; a mixed format bit generation circuit connected to said inversion control unit; and
a final result adder for generating a product from said set of partial products.

2. A multiplier according to claim 1, further comprising means for combining said set of partial products to form inputs to said final result adder.

3. A multiplier according to claim 1, further comprising means for accepting two n-bit inputs, whereby said multiplier may operate on two n-bit unsigned numbers, two n-bit two's complement numbers, and one n-bit unsigned number and one n-bit two's complement number.

4. A multiplier according to claim 2, in which said inversion control unit responsive to an input format signal specifying the format of the operands and contains circuitry to generate control signals to said first MSB array, second MSB array and third MSB array in said left column and last row by inverting the contents of said first and third MSB arrays when only said first operand is signed, inverting the contents of said second and third MSB arrays when only said second operand is signed, and inverting the contents of both said first and second MSB arrays when both said first and second operands are signed.

5. A multiplier according to claim 4, in which said signed bit generation circuit responsive to said input format signal specifying the format of the operands contains circuitry for (a) adding a logic value to an nth bit of the output of said multiplier and (b) adding a logic value to an (n+1)th bit of the output when both operands are in two's complement format.

6. A multiplier according to claim 5, in which said mixed format bit generation circuit contains circuitry for adding a logic value to a 2nth bit of the output.

7. A multiplier according to claim 1, further comprising pipeline means, whereby at least one earlier stage operates on a later pair of operands while at least one later stage operates on a first pair of operands.

8. A multiplier according to claim 3, further comprising pipeline means, whereby at least one earlier stage operates on a later pair of operands while at least one later stage operates on a first pair of operands.

9. A multiplier according to claim 4, further comprising pipeline means, whereby at least one earlier stage operates on a later pair of operands while at least one later stage operates on a first pair of operands.

10. A multiplier according to claim 5, further comprising pipeline means, whereby at least one earlier stage operates on a later pair of operands while at least one later stage operates on a first pair of operands.

11. A multiplier adapted for operating on operands represented in any combination of two's complement and unsigned magnitude formats, comprising:
a partial product generation and reduction unit having a set of partial product generators, at least some of which contain means for generating a carry bit, comprising a set of partial product generating units, in which units on the left column and on the last row include controllable means for inverting the partial product generated therein in response to a signal from an inversion control unit;
an inversion control unit connected to said units on the left column and on the last row;
a signed bit generation circuit;
a mixed format bit generation circuit; and
a final result adder.

12. A multiplier comprising means for generating a set of partial products of two operands and for combining said set of partial products to form a final product, further comprising:
inversion control means for controllably inverting the partial products A[n]B[j], A[n]B[n] and A[j]B[n], (where index [n] designates the most significant bit of an operand, and j is an index in the range from 1 to n−1); and
means for controllably adding ‘1’ in the 2nth position, (n+1)th position and nth position of the product.

13. A multiplier according to claim 12, further comprising means for accepting two n-bit inputs, whereby said multiplier may operate on two n-bit unsigned numbers, two n-bit two's complement numbers, and one n-bit unsigned number and one n-bit two's complement number.

14. A multiplier according to claim 13, in which said inversion control means is responsive to an input format signal specifying the format of the operands and contains circuitry to generate control signals to a first MSB array (containing A[n]B[j] (where index [n] designates the most significant bit of an operand, and j is an index in the range from 1 to n−1), a second MSB array (containing A[j]B[n]), and a third MSB array containing A[n]B[n] for inverting the contents of said first and third MSB arrays when only said first operand is signed, inverting the contents of said second and third MSB arrays when only said second operand is signed, and inverting the contents of both said first and second MSB arrays when both said first and second operands are signed.

15. A multiplier according to claim 12, further comprising pipeline means, whereby at least one earlier stage operates on a later pair of operands while at least one later stage operates on a first pair of operands.

16. A multiplier according to claim 13, further comprising pipeline means, whereby at least one earlier stage operates on a later pair of operands while at least one later stage operates on a first pair of operands.

17. A multiplier according to claim 14, further comprising pipeline means, whereby at least one earlier stage operates on a later pair of operands while at least one later stage operates on a first pair of operands.
